(19) United States
(12) Patent Application Publication
(10) Pub. No.: US 2006/0137403 A1
(43) Pub. Date: Jun. 29, 2006

(54) High energy fiber terminations and methods

(76) Inventors: Brian D. Barr, Scottsdale, AZ (US); Stephen E. Griffin, Glendale, AZ (US)

Correspondence Address: The Halvorson Law Firm, Ste 130, 1757 E. Baseline, Gilbert, AZ, 85233, US

(21) Appl. No.: 11/026,930

(22) Filed: Dec. 29, 2004

(51) Int. Cl. C03B 37/07; C03B 37/15; G02B 6/32

(52) U.S. Cl. 65/377; 65/387; 65/392; 385/33

(57) ABSTRACT

Fiber optic end faces produced by laser ablation, as opposed to “cleave” or mechanical polish, offer advantages in some severe environment applications such as laser surgery and delivery of extremely high energy density. The “laser polished” fiber faces are more resistant to physical damage as well as less prone to damage other structures, owing to a lack of sharp, fragile edges and laser polished faces may be formed on fibers in planes and curvatures normal to the fiber axis or off normal, as desired.

### FIELD OF THE INVENTION

The present invention relates generally to applications of lasers to the processing of “bare” optical fiber ends (termini) and the application of fibers so terminated to laser surgery and in delivery of extreme energy density, where damage to traditionally prepared fiber termini occurs principally through laser damage, hydrothermal corrosion and metal ion catalyzed devitrification or combinations thereof.

### BACKGROUND OF THE INVENTION AND DESCRIPTION OF THE PRIOR ART

Most fused silica optical fiber intended for use in high energy transmission is mechanically polished or “cleaved” (the latter being a misnomer since fused silica fiber is amorphous). Mechanically polished ends generally fail at high energy density by pitting, where the pits are thought to originate from stress foci or embedded polishing media that are artifacts of the mechanical polishing methods. Cleaved fibers are thought to perform best, but cleaves of adequate quality are difficult to produce on non-telecom dimension fiber, are difficult to reproduce, can result in some angular fiber face character (off normal to the laser axis) and necessarily result in some damage to the glass edge. In reality, both cleave and mechanical polish methods leave residual damage on the fiber, on the cladding (glass outer diameter) or on the fiber face, areas that present foci upon which further damage initiates.

In laser surgery, where cleaved or polished fibers are in contact with aqueous solutions and/or tissues containing alkali and alkaline earth metal ions, and where operating temperatures can be quite high, where even minor damage on the fiber exists, fiber ends present a locus for initiation of hydrothermal corrosion, metal ion catalyzed devitrification and penetration. So called “laser polished” fibers offer higher thresholds for damage onset and delay of onset at damage threshold but prior art laser polished fibers are of limited utility due to an inability to form truly flat fiber faces (normal to the fiber axis and planar) without use of accessory ferrules.

Griffin (U.S. Pat. No. 6,282,349) discloses fibers with laser polished, high damage threshold faces but these faces must be formed within the confines of a hermetic accessory ferrule, due to an inability to control (limit) the extent of glass melting at the fiber edges of bare fiber.

Various patents disclose lens-ended bare fibers, manufactured by polishing, etching and laser ablation, but no laser ablation method is shown to produce optically flat core cross-sections on low cladding to core diameter ratio (CCDR) fiber. And while the improved laser damage threshold of laser-produced fiber termini is generally known, the environmental damage-resistant properties of such laser-formed terminations are not.

Therefore, there is a need for a novel method of forming planar fiber faces without accessory ferrules as is disclosed herein, along with the advantages offered in select applications.

### SUMMARY OF THE INVENTION

The invention disclosed herein comprises fused silica core optical fibers with one or more “bare” ends, with the output finish produced by laser ablation/melt for use in coupling high energy density and for applications in chemically and physically harsh environments. Methods of producing these flat, bare fiber ends, from a molten surface state without distortion of the fiber output, are also disclosed.

In some applications, such as endoscopic surgery, where the fiber must pass through highly flexible working channels, some degree of edge rounding is desirable. Traditionally prepared fiber tips—by “cleaving” or by mechanical polish—leave relatively sharp fiber edges that are susceptible to damage by chipping and that may damage delicate tissues and liners of endoscopic channels. The slightly rounded edges that result from the “laser polish” disclosed herein resist damage and present less of a threat of damage to other objects.

Finally, in some applications it may be desirable to form controlled curvature finishes on bare fibers, for example concave or convex surfaces, or finishes at other than 90° to the fiber axis, for example at the critical angle as defined by Snell's Law for directing energy off-axis rather than on axis, or some combination of both. In surgeries that are performed with laser energy within bodily lumen, where target tissues are within the lumen wall, a laser formed angular polish offers additional control of the output beam characteristics and provides a more reproducible and damage resistant termination than polishing by traditional methods.

For example, in laser prostatectomy, 0.22 NA fibers are typically mechanically polished to an angle of approximately 35° to 38° for directing energy off axis at 70° to 76°. This polished fiber end is difficult to produce with angular precision and a high quality surface. Further, in installing such polished fibers within protective caps (necessary for preserving the refractive index difference that defines the critical angle), chip damage can result at the delicate leading edge of the beveled fiber that renders the device useless.

Among the objects of the present invention are the following:

To provide a new and useful fiber end termination for resistance to damage in chemically harsh environments;

To provide a new and useful fiber end termination for resistance to damage in physically harsh environments;

To provide a new and useful fiber end termination for resistance to damage in laser surgery;

To provide a new and useful fiber end termination for resistance to damage in surgery of soft tissues;

To provide a new and useful fiber end termination for resistance to damage in laser lithotripsy;

To provide a new and useful fiber end termination for resistance to damage in laser surgery of cartilaginous tissues;

To provide a new and useful fiber end termination for resistance to damage in laser surgery of hard tissues;

To provide a new and useful fiber end termination for resistance to damage in laser surgery within bodily fluids;

To provide a new and useful fiber end termination for resistance to physical damage in passing through lumen, such as endoscopic working channels and protective end caps;

To provide a new and useful fiber end termination for reducing risk of damage to lumen, such as vessels in the body and endoscopic working channels, while advancing bare-end fibers;

To provide a new and useful fiber end termination capable of shaping beam output of lateral delivery fibers;

To provide a new and useful fiber end termination for resistance to damage in coupling high energy density;

To provide a new and useful method of forming “standard”, flat surface terminations with laser energy; and

To provide a new and useful method of forming curved surface terminations with laser energy, on planes normal to and other than normal to the fiber axis.

The novel features that are considered characteristic of the invention are set forth with particularity in the appended claims. The invention itself, however, both as to its structure and its operation together with the additional objects and advantages thereof will best be understood from the following description of the preferred embodiment of the present invention. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments of the invention is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWING

FIG. 1 is side view in section along the centerline of a low CCDR silica core, doped silica clad fiber that is representative of prior art.

FIG. 2 is a side view in section along the centerline of a low CCDR silica core fiber, doped silica clad fiber polished at an angle off normal to the fiber axis that is representative of prior art.

FIG. 3 is a side view in section taken generally along the centerline of the same fiber in FIG. 1 that is a product of the new art.

FIG. 4 is a side view in section along the centerline of a low CCDR silica core fiber, doped silica clad fiber polished at an angle off normal to the fiber axis, as in FIG. 2, that is a product of the new art.

FIG. 5 is a diagram of the basic elements required to produce the high damage threshold fiber termini disclosed herein.

FIG. 6 is a side view in section taken generally along the centerline of a fiber where a concave surface is formed instead of a planar surface.

FIG. 7 is a side view in section taken generally along the centerline of an off-normal angle polished fiber where the finish is non-planar and convex.

FIG. 8 is a side view in section taken generally along the centerline of an off-normal angle polished fiber where the finish is non-planar and concave.

FIG. 9 is a side view in section taken generally along the centerline of an off-normal angle polished fiber where the finish is multiplanar.

FIG. 10 is a block diagram of the basic elements required to produce off normal axis laser finished fibers.

### DESCRIPTION OF THE PREFERRED EMBODIMENT

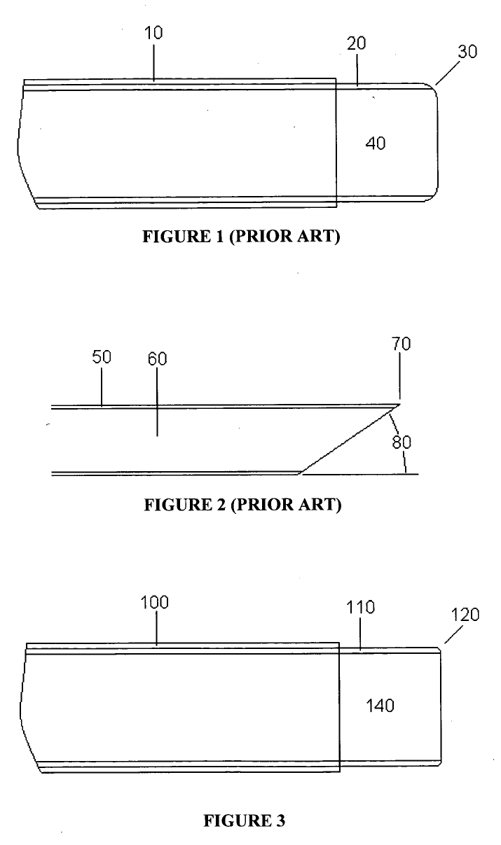

In prior art methods of laser processing bare fiber tips, the heat applied to the fiber—of sufficient concentration to produce the bulk vaporization and surface melt effects—conducts to the fiber edges where excessive rounding results. FIG. 1 illustrates the best case resulting from use of a CO₂ laser to flat-polish a low CCDR fiber, where 10 is the fiber buffer coating (polymer), 20 is the doped glass cladding and 30 is edge rounding that distorts the silica core 40. In the simplest variation of the current art, illustrated in FIG. 5, the opening of a small vacuum tube 210 connected to a vacuum motor is positioned just below the focal point of the laser 240 on a fiber 200 with the fiber 200 centered in the vacuum tube opening in rotation. For flat polished surfaces, and concave, fiber 200 is located within collet 205 and is rotated at an angle 215 that is approximately the same as the focal angle 225 of the laser. The flow of air around the fiber 200 serves to cool the distortion-prone edge of the fiber during laser forming and reducing any rounding sufficient to produce an optically flat face across the entire core of the fiber 200. Concavity may be accomplished simply through control of the total laser energy in the focal point 240 on the fiber 200 as natural attenuation and refraction within the silica results in concavity. The radius of the concave surface is dependent upon laser power, cooling gas flow rate and nozzle position and the fiber angle and position relative to the laser focus.

As illustrated in FIG. 3, the rounding 120 is confined to the doped glass cladding region 110, so the light output of the fiber is unaffected as opposed to traditional flat finishes. The method according to the present invention is further enhanced by providing computer-controlled motion control in the vertical, horizontal and laser beam axes as well as in the angular approach of the fiber 200 to the laser beam axis. As an alternative to rotating the fiber 200 within the laser focal spot 240, the laser beam 220 may be rotated about the fiber 200. By controlling the fiber angle 215 with respect to the laser focus 240 and the laser focus position relative to the fiber 200 center, surfaces from optically flat to parabolic to aspheric are formed, in concave and convex profiles. By controlling the horizontal and vertical position of the fiber 200 with respect to the laser focus 240, without rotation, multiplanar surfaces may be prepared.

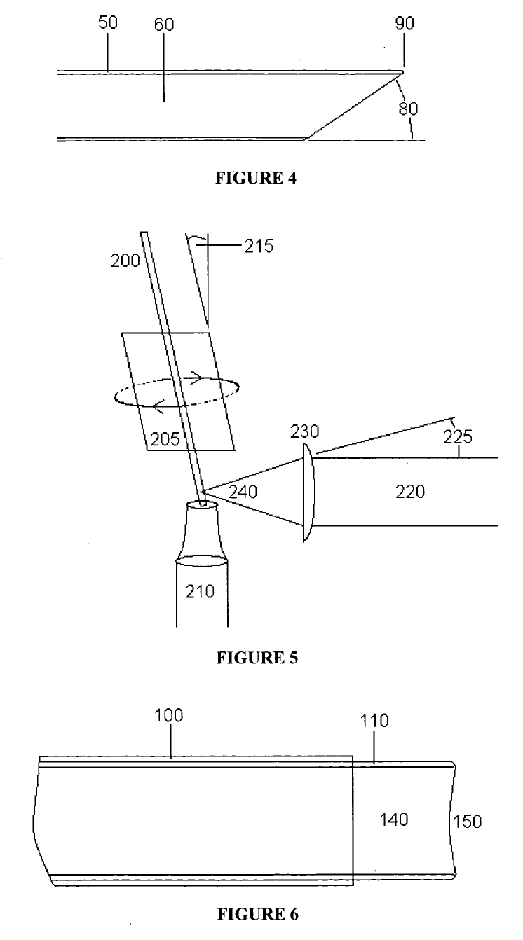

FIG. 2 depicts an example of prior art angular polish for lateral energy delivery where 80 is the critical angle defined by Snell's Law and 70 is the delicate, chip susceptible tip. FIG. 4 depicts the new art version of the same fiber preparation, where 80 is the critical angle defined by Snell's law and 90 is the chip resistant slightly rounded fiber tip.

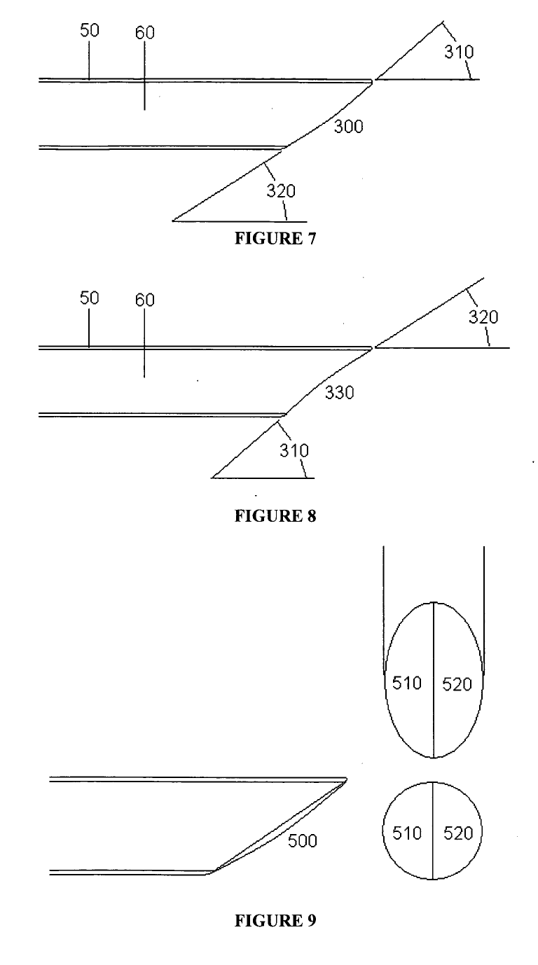

FIG. 6 depicts a beam shaping option possible with the methods disclosed herein, in this case a convex surface 150 preparation by laser ablation. FIG. 7 depicts an analogous beam shaping surface preparation made possible with the art disclosed herein, where the maximum angle 310 and the minimum angle 320 that define the extremes of the convex or parabolic surface 300, and all of the angles in between, satisfy the requirements of Snell's Law for complete reflection of all mode angles transmitted within the fiber. FIG. 8 depicts a concave variation of the lateral fiber end preparation where 310 and 320 again define the maximum and minimum angles for the complex or curved surface 330 formed, where the extreme angles and all angles within those extremes satisfy the requirements of Snell's Law for total internal reflection in redirecting all mode angles within the fiber off the fiber axis.

In further clarification of the requirements for redirecting energy laterally with respect to the fiber axis, the highest angle relative to the fiber axis in both FIG. 7 and FIG. 8 is 310; which must satisfy the requirements set out by Snell's Law for reflecting the worst case mode within the fiber core 60. The calculated maximum off-axis angle 310 result is dependent upon the wavelength(s) of light transmitted by the fiber (the refractive indices of the core and surrounding medium are dependent upon the wavelength), the nature of the medium that lies just outside the angle polish (typically air or a partial vacuum) and the worst case angle of approach for the highest order ray to the angle polished surface. All angles lower than the maximum polish angle, with respect to the fiber axis will also reflect the light within the fiber, rather than permit the light to pass through the surface 300 and 330, according to Snell's Law. While flat angular polished fibers and their utilities are well described in prior art, curved and multifaceted surfaces have not been disclosed, nor have the advantages offered by such surfaces been described.

Angle polished fibers are commonly deployed and sealed within protective caps designed to preserve the cleanliness of the critical reflective fiber face. In most variations of this strategy, significant Fresnel reflections and beam output distortions are a consequence of the laterally directed light impinging and traversing the highly curved surfaces presented by the surrounding, cylindrical protective cap. By enabling production of surfaces that amount to focusing mirrors, rather than being limited to flat reflective surfaces, Fresnel reflections may be significantly reduced and distortions corrected. In addition, lateral fiber output beam profiles may be shaped to some degree, permitting control of energy density and distribution for enhanced performance. In combination with other art, such as Numerical Aperture compression prior to the fiber angle polish, as disclosed in Griffin (U.S. Pat. No. 6,687,436), and/or fusion of the fiber to the inner cap surface, with or without production of flat surfaces and/or altered curvatures on the outer diameter of protective caps, as disclosed in Griffin (U.S. Pat. No. 5,562,657), a great degree of control of undesirable reflective loss and shaping of output profile is afforded.

FIG. 9 depicts another possible variation for output beam shaping, where two planes or curvatures, 510 and 520, within the confines of the critical angle, intersect at the center 500 of the long or short fiber polish axis.

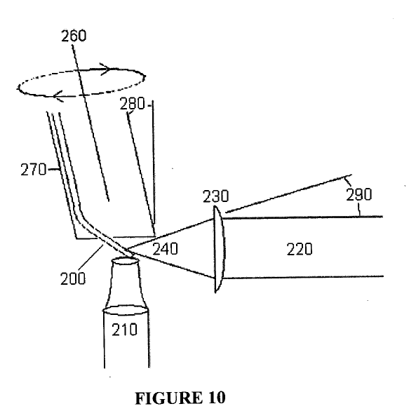

FIG. 10 depicts the necessary fiber 200 orientation within the rotating collet for producing angle polishes. For flat finishes, the fiber 200 is mounted within an asymmetric collet 270 such that the fiber passes through the axis of rotation at an angle and is rotated within the laser focus 240 at an angle 280 approximately equivalent to the laser focal angle 290 while positioned just above and centered within the opening to the vacuum source 210. As with laser polished ends normal to the fiber axis, angle polishing may be preformed by rotating the fiber with respect to the laser focus, using the illustrated complex, asymmetric mounting or more simply, by rotating the laser focus relative to the fiber axis. Computer motion control offers additional control of surface profiles formed, although it is not strictly required for the simpler flat and curved embodiments.

As with the fiber end finishes that are normal to the fiber axis, angled finishes may be. produced that are not fully symmetrical. In the angle polish case, rotation may still be used in some oriented, multiplanar surface formation but some variations require the fiber rotation to be ceased. Curved, oriented surfaces on the angled fiber face may also be formed by forming planar faces that are subsequently melted slightly with the laser, with or without rotation.

The preferred embodiment of the invention is described above in the Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventors that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A method for processing fiber optic tips comprising the steps of
a. providing a fiber tip;
b. providing a fluid flow over the fiber tip;
c. rotating the fiber tip in the fluid flow;
d. placing the rotating fiber tip at the focal point of a laser output equipped with a focusing optic for a time sufficient to process the fiber tip; and
e. removing the processed fiber tip from the focal point of the laser focus.

2. The method according to claim 1 wherein the fiber tip is rotated at an angle relative to the laser beam propagation axis that is approximately the same as the focal angle of the laser.

3. The method according to claim 2 wherein the focal point of the laser output is centered on the fiber center.

4. The method according to claim 2 wherein the focal point of the laser output is not centered on the fiber center.

5. The method according to claim 1 wherein the fiber tip is rotated asymmetrically such that the fiber passes through the axis of fiber rotation at an angle.

6. The method according to claim 5 wherein the focal point of the laser output is centered on the fiber center.

7. The method according to claim 5 wherein the focal point of the laser output is not centered on the fiber center.

8. The method according to claim 2 wherein the fiber tip is rotated asymmetrically such that the fiber passes through the axis of fiber rotation at an angle.

9. The method according to claim 8 wherein the focal point of the laser output is centered on the fiber center.

10. The method according to claim 8 wherein the focal point of the laser output is not centered on the fiber center.

11. A method for processing fiber optic tips comprising the steps of
a. providing a fiber tip;
b. providing a fluid flow over the fiber tip;
c. placing the fiber tip at the focal point of laser output equipped with a focusing optic for a time sufficient to process the fiber tip;
d. rotating the focal point of the laser output about the fiber tip for a time sufficient to process the fiber tip; and
e. removing the processed fiber tip from the focal point of the laser output.

12. The method according to claim 11 wherein the focal point is rotated at an angle that is not perpendicular to the fiber.

13. The method according to claim 11 wherein the fiber is also rotated.

14. The method according to claim 11 wherein the focal point of the laser output is centered on the fiber center.

15. The method according to claim 11 wherein the focal point of the laser output is not centered on the fiber center.

16. A fiber tip that as been processed by flowing a fluid over the tip while a focused laser has processed the fiber tip.

17. The fiber tip according to claim 16 with a symmetric surface.

18. The fiber tip according to claim 17 with a flat surface.

19. The fiber tip according to claim 17 with a convex surface.

20. The fiber tip according to claim 17 with a concave surface.

21. The fiber tip according to claim 16 with an asymmetric surface.

22. The fiber tip according to claim 16 with a multiplanar surface.
